(19) United States
(12) Patent Application Publication
(10) Pub. No.: US 2007/0242388 A1
(43) Pub. Date: Oct. 18, 2007

(54) Disc Clamp Having Force Distributing Features

(75) Inventors: Bulent Goksel, Braintree, MA (US); Michael D. Leis, Framingham, MA (US)

Correspondence Address: Westman, Champlin & Kelly;Suite 1400, 900 Second Avenue South, Minneapolis, MN, 55402-3244, US

(73) Assignee: MAXTOR CORPORATION, Scotts Valley, CA (US)

(21) Appl. No.: 11/733,894

(22) Filed: Apr. 11, 2007

Related U.S. Application Data
(60) Provisional application No. 60/744,917, filed on Apr. 14, 2006.

(51) Int. Cl. G11B 17/02

(52) U.S. Cl. 360/99.12

(57) ABSTRACT

A disc clamp is provided for securing discs to a spindle motor. In particular, the clamp is useful in providing distributed forces to the discs. The clamp includes an annular body having an upper surface, a lower surface, an inner circumference and an outer circumference. A flange extends from the lower surface of the annular body and has an inner surface oriented towards the inner circumference of the annular body. A plurality of apertures are formed between the upper and lower surfaces of the annular body and are configured to receive fasteners. Further, a plurality of force distributing features are formed in the flange between the outer surface of the flange and the inner surface of the flange.

### CROSS REFERENCE TO RELATED APPLICATIONS

This application claims the benefit of U.S. Provisional Application No. 60/744,917, filed on Apr. 14, 2006, entitled “Spindle Disc Clamp with Improved Repeatable Run-Out”, the disclosure of which is incorporated herein by reference in its entirety.

### BACKGROUND

Data storage systems typically include one or more data storage discs mounted to a spindle hub. A spindle motor rotates the spindle hub at high RPMs during operation. Disc clamps are utilized to secure the data storage discs to the spindle hub.

Disc clamps provide the force necessary to secure the discs to the hub of the disc drive. Specifically, the disc clamp provides enough force to prevent the discs from displacing, both radially and axially, with respect to the hub. Preventing the discs from slipping or moving relative to the hub during rotation ensures that accurate read/write operations can be conducted. Additionally, during shock events, the disc clamp can adequately secure the one or more discs in place to prevent damage to the disc(s).

In some instances, a disc clamp provides an uneven force distribution to secure the data storage disc(s) to the spindle hub. For example, when fasteners, such as screws, are utilized to secure the clamp to the hub, the fasteners transmit uneven and irregular forces through the clamp to the data disc that are both radially and axially oriented. These irregular clamping forces can result in the production of surface irregularities and/or distortion. Any distortion of a disc read/write surface can result in reduced head transducer flight characteristics. For instance, “disc coning” can occur due to uneven clamping force and results from axial displacement of discs in a data storage system.

### SUMMARY OF THE INVENTION

A disc clamp is provided for securing one or more discs to a spindle motor. The clamp includes an annular body having an upper surface, a lower surface, an inner circumference and an outer circumference. A flange extends from the lower surface of the annular body and includes an inner surface oriented towards the inner circumference of the annular body and an outer surface. A plurality of apertures configured to receive fasteners extend between the upper and lower surfaces of the annular body. A plurality of force distributing features are formed in the flange between the outer surface of the flange and the inner surface of the flange. The force distributing features enable the clamp to provide uniform or substantially uniform clamping force. In some embodiments, the disc clamp does not include a flange and the force distributing features are formed in the annular body.

These and various other features and advantages will be apparent from a reading of the following Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is an exploded perspective view of a disc drive.

FIG. 2 is a sectional view of an exemplary disc pack.

FIG. 3 is a top perspective view of a disc clamp under one embodiment.

FIGS. 4 and 5 are top and bottom perspective views of a section of a disc clamp including force distributing features under one embodiment.

FIG. 6 is a bottom perspective view of a section of a disc clamp including force distributing features under one embodiment.

FIG. 7 is a bottom perspective view of a section of a disc clamp including force distributing features under one embodiment.

FIG. 8 is a bottom perspective view of a section of a disc clamp including force distributing features under one embodiment.

FIG. 9 is a bottom perspective view of a section of a disc clamp including force distributing features under one embodiment.

FIG. 10 is a top perspective view of a disc clamp including force distributing features formed on an outer peripheral surface of the clamp under one embodiment.

FIG. 11 is a bottom perspective view of a section of a disc clamp including force distributing features under one embodiment.

FIG. 12 is a top perspective view of a spacer including force distributing features under one embodiment.

FIG. 13 is a graphical representation illustrating the force distribution characteristics of at least some of the embodiments described herein.

### DETAILED DESCRIPTION OF THE DRAWINGS

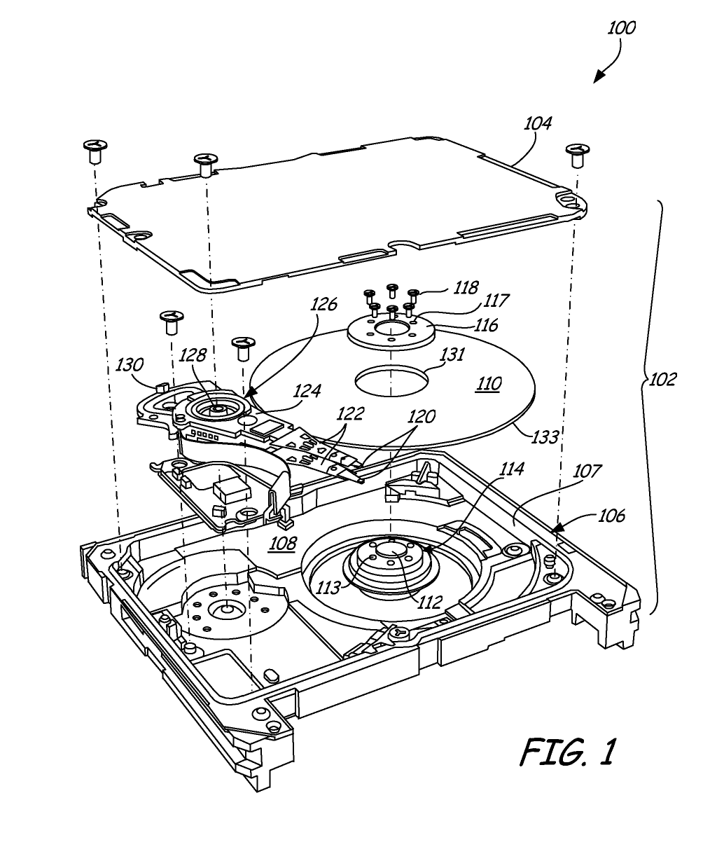

FIG. 1 is an exploded perspective view of a disc drive 100 in accordance with embodiments of the disclosure. Disc drives are common data storage systems. One or more embodiments of the present invention are also useful in other types of systems.

Disc drive 100 includes a housing 102 having a cover 104 and a base 106. As shown, cover 104 attaches to base 106 to form an enclosure 108 enclosed by a perimeter wall 107 of base 106. The components of disc drive 100 are assembled to base 106 and are enclosed in enclosure 108 of housing 102. As shown, disc drive 100 includes a medium 110 which is a disc. Although FIG. 1 illustrates medium 110 as a single disc, those skilled in the art should understand that more than one disc can be used in disc drive 100. Medium 110 stores information in a plurality of circular, concentric data tracks and is mounted on a spindle motor assembly 114 by a disc clamp 116 and a hub 112. Disc clamp 116 is mounted to the hub 112 by a plurality of fasteners 118 which can be inserted through apertures 117 formed in the disc clamp 116 and received by apertures 113 formed in the hub 112. In one embodiment, fasteners 118 are screws. Spindle motor assembly 114 rotates medium 110 causing its data surfaces to pass under respective hydrodynamic bearing slider surfaces. Each surface of medium 110 has an associated slider 120, which carries transducers that communicate with the surface of the medium.

In the example shown in FIG. 1, sliders 120 are supported by suspension assemblies 122, which are, in turn, attached to track accessing arms 124 of an actuator mechanism 126. Actuator mechanism 126 is rotated about a shaft 128 by a voice coil motor 130. Voice coil motor (VCM) 130 rotates actuator mechanism 126 to position sliders 120 relative to desired data tracks, between a disc inner diameter 131 and a disc outer diameter 133.

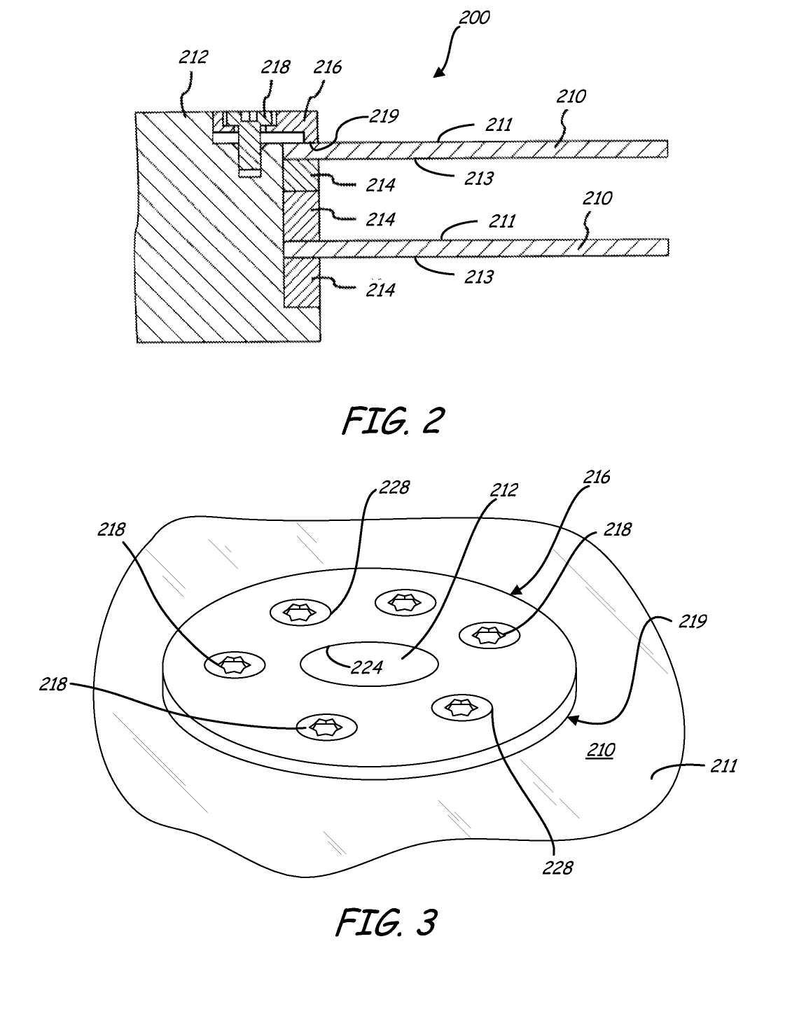

FIG. 2 is a sectional view of an exemplary disc pack 200. In one embodiment, disc pack 200 is configured for use in a data storage system similar to disc drive 100 illustrated in FIG. 1. Pack 200 includes at least one disc 210 mounted on a hub 212. Further, in one embodiment, spacers 214 are mounted on hub 212 and are configured to provide spacing between discs 210. While disc pack 200 is illustrated as including two disc 210 and three spacers 214, any number of discs and spacers can be utilized.

Disc pack 200 includes a disc clamp 216 configured to secure disc(s) 210 to the hub 212. As illustrated, clamp 216 is secured to hub 212 using at least one fastener 218 (e.g., a screw). In other embodiments, clamp 216 is secured to hub 212 without the use of screws 218. A bottom surface 219 of the clamp 216 contacts an upper surface 211 of a disc 210 to secure the disc(s) 210 on hub 212 of disc pack 200. Further, disc clamp 216 also includes at least one feature (not shown in FIG. 2) configured to distribute forces generated by fasteners 218 to a surface of disc 210 in a substantially uniform manner. The features of clamp 216 configured to distribute force are collectively referred to as force distributing features and are formed by incorporating weakening or strengthening features in the clamp by selectively removing material or thickening material in sections of the clamp.

In one embodiment, disc pack 200 is assembled by placing a first spacer 214 on the disc hub 212. A first disc 210 is placed on disc hub 212 such that a bottom surface 213 of the disc 210 engages the first spacer 214. A second spacer 214 is placed on disc hub 212 to engage an upper surface 211 of the first disc 210. As illustrated in FIG. 2, a plurality of spacers 214 can be placed on the disc hub 212 between the first disc 210 and a second disc 210. In one embodiment, two spacers 214 are placed between the discs 210. In another embodiment, a single spacer 214 is placed between the discs 210. Further, more than two spacers 214 can be positioned between the discs 210. Disc clamp 216 is placed adjacent the top disc 210 such that the bottom surface 219 of the disc clamp 216 engages a top surface 211 of the disc 210. Fasteners 218 are utilized to secure the clamp 216 to the disc hub 212 and provide downward clamping force to the top surface 211 of disc 210. As described above, any number of discs 210 and spacers 214 can be utilized in disc pack 200.

FIG. 3 is a top perspective view of one embodiment of disc clamp 216. Disc clamp 216 includes an inner circumference 224 adapted to receive hub 212. Further, a plurality of fastener receiving apertures 228 are formed in clamp 216. Fasteners 218 are utilized to secure disc clamp 216 to the hub 212. The bottom surface 219 of the disc clamp 216 is configured to engage an upper surface 211 of disc 210 and provide downward clamping force to secure the disc 210 (or plurality of discs) to hub 212.

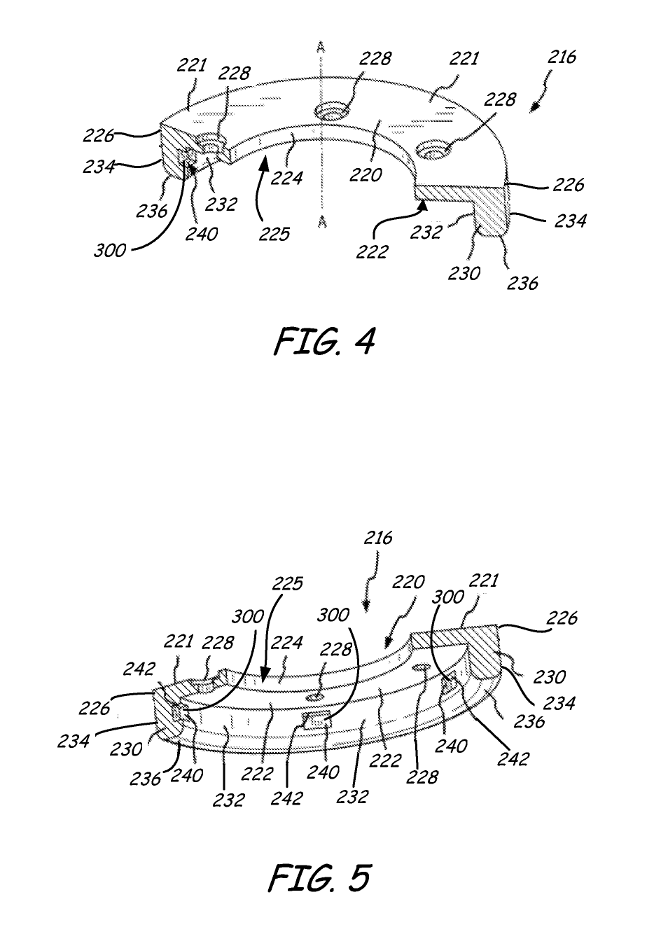

FIGS. 4 and 5 are top and bottom perspective views of a section of disc clamp 216 illustrated in FIG. 3 under one embodiment including force distributing features 240. Disc clamp 216 is configured to engage an underlying disc or spacer in a data storage system. Disc clamp 216 includes an annular body 220 having an upper surface 221, lower surface 222, the inner circumference 224, and an outer circumference 226. Lower surface 222 defines at least a portion of a bottom surface of the disc clamp 216. In one embodiment, the inner circumference 224 defines an opening 225 configured to receive a hub of a spindle motor, such as hubs 112 and 212. A plurality of apertures 228 for receiving fasteners are formed in the annular body 220 and extend between the upper surface 221 and lower surface 222.

Annular body 220 also includes a flange 230 that extends from the lower surface 222. In one embodiment, flange 230 extends substantially orthogonal to or perpendicular to the annular body 220. Further, flange 230 can be integrally formed with the annular body 220 or can be secured thereto by any means of attachment. The flange 230 has an inner surface 232 that is oriented in the same direction as the inner circumference 224 of the annular body 220, and an outer surface 234. In one embodiment, the flange 230 is positioned such that the outer surface 234 aligns with the outer circumference 226 of the annular body 220. In other embodiments, the outer surface 234 can be offset from the outer circumference 226 of the annular body 220.

In the embodiments illustrated in FIGS. 4 and 5, the flange 230 includes a lower surface 236. Thus, in this embodiment, the lower surface 236 of the flange 230 is configured to contact a surface of an underlying disc or spacer. In one embodiment, the lower surface 236 of the flange 230 is slightly curved or rounded. In another embodiment, the lower surface 236 is substantially flat or planar. Further, in accordance with one embodiment, clamp 216 is symmetrical, or substantially symmetrical, about an axis A-A.

The clamp 216 illustrated in FIGS. 4 and 5 includes force distributing features 240 in the form of rectangular shaped recesses 300. As illustrated in FIGS. 4 and 5, the force distributing features 240 can be radially aligned with the fastener receiving apertures 228. In other embodiments, the force distributing features 240 can be radially offset from the apertures 228. Further, the upper edges 242 of the force distributing features 240 can be spaced below the lower surface 222 of the annular body 220 (FIG. 5). Accordingly, in this embodiment the force distributing features 240 are not located on the same general plane as the screw holes 228.

As will be discussed below, the force distributing features 240 can be any shape and configuration suitable for distributing forces in disc clamp 216. For instance, the force distributing features 240 can be provided in various shapes and sizes including, but not limited to, rectangular, square, triangular, circular, or oval shaped features formed in the clamp.

In one embodiment, the recesses 300 extend from the inner surface 232 of the flange 230 toward the outer surface 234 of the flange 230. In another embodiment, the recesses 300 extend from the outer surface 234 of the flange 230 toward the inner surface 232 of the flange 230. Additionally, in some embodiments the force distributing features 240 comprise openings extending through the flange 230 (i.e., extending from the outer surface 234 to the inner surface 232).

In embodiments described herein, clamp force distribution is improved while the overall clamp stiffness is not significantly reduced which otherwise would weaken the overall structural integrity of the clamp 216. In other words, embodiments described herein enable the clamp 216 to maintain its spring-like qualities while providing force distributing characteristics. Embodiments of disc clamp 216 and the force distributing features 240 will be discussed in further detail below.

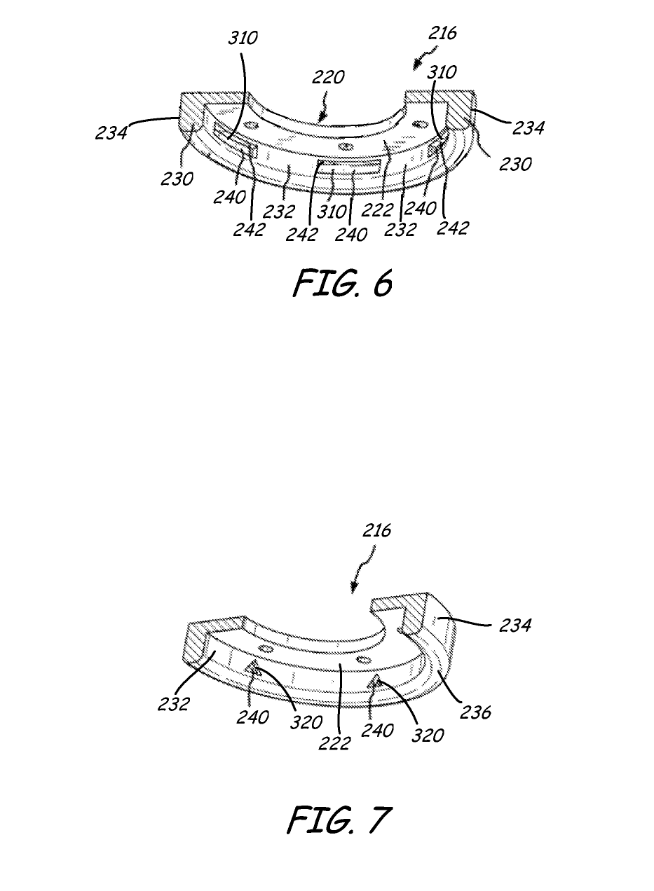

FIG. 6 illustrates one embodiment of disc clamp 216 illustrated in FIG. 3 including force distributing features 240 comprising rectangular recesses 310. Recesses 310 are illustratively larger than the recesses 300 illustrated in FIGS. 4 and 5. As discussed above, in one embodiment recesses, 310 extend from the inner surface 232 toward the outer surface 234. In another embodiment, recesses 310 extend from the outer surface 234 toward the inner surface 232. Further yet, the recesses 310 can be configured as openings extending through the flange 230 (i.e., from the inner surface 232 to the outer surface 234). As illustrated in FIG. 6, the upper surfaces 242 of the force distributing features 240 are spaced from the lower surface 222 of the annular body 220.

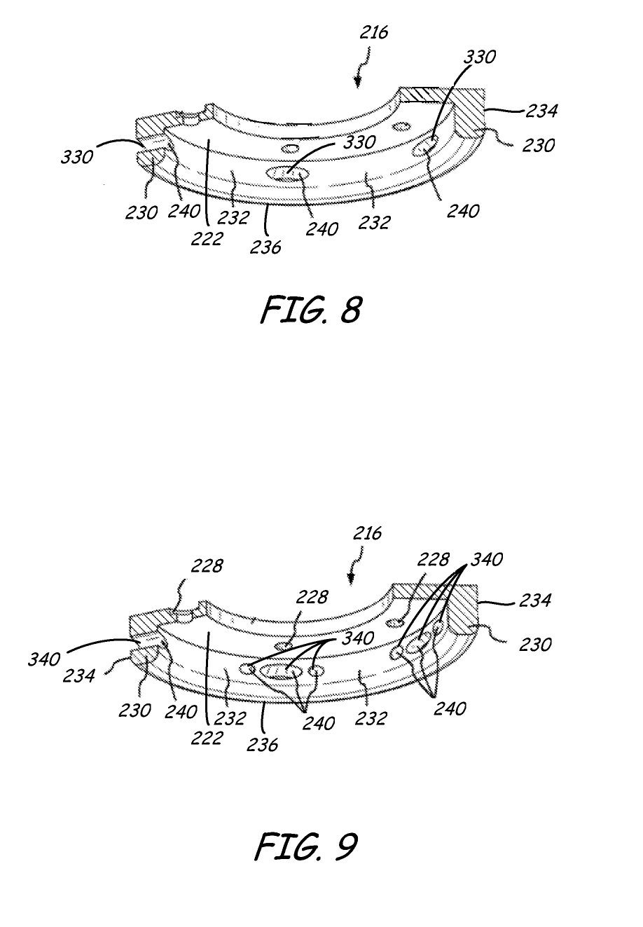

FIGS. 7-9 illustrate further embodiments of disc clamp 216 illustrated in FIG. 3 including force distributing features 240. In FIG. 7, the force distributing features 240 comprise a plurality of triangular shaped recesses 320. In FIG. 8, the force distributing features 240 comprise a plurality of elliptical or circular shaped recesses 330. In FIG. 9, the force distributing features 240 comprise a plurality of recesses 340 having varying shapes and sizes. In one embodiment, recesses 340 form a pattern of features including both large and small recesses. In the embodiment illustrated in FIG. 9, the recesses 340 form groups of recesses positioned relative to each aperture 228. In one embodiment, each group of recesses includes a larger recess radially centered relative to each aperture 228 and two smaller recess positioned on either side of the larger recess.

In each of the above described embodiments, it shall be understood that the force distributing features 240 can comprise recesses that extend from the inner surface 232 toward the outer surface 234, recesses that extend from the outer surface 234 toward the inner surface 232, or openings formed through the flange 230 (i.e., from the inner surface 232 to the outer surface 234). Further, it is noted that any combination of sizes and shapes of force distributing features 240 can be utilized. As mentioned above, it is also desirable to have the force distributing features 240 spaced from the lower surface 222 of the annular body 220 and the lower surface 236 of the flange 230 so as to not weaken the spring-like quality of the clamp.

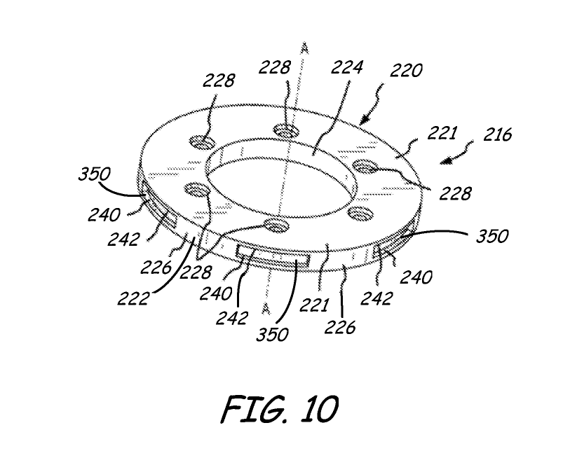

FIG. 10 illustrates another embodiment of disc clamp 216 illustrated in FIG. 3. In this embodiment, disc clamp 216 comprises an annular body 220 having fastener receiving apertures 228 formed therein. The annular body 220 has an inner circumference 224 adapted to receive a hub of a spindle motor, such as hubs 112 or 212. An outer circumference 226 of the annular body 220 includes a plurality of force distributing features 240 formed thereon. The force distributing features 240 comprises a plurality of rectangular shaped recesses 350. In other embodiments, recesses 350 can be any suitable size and shape, such as those mentioned above with regard to FIGS. 4-9. The upper edges 242 of the recesses 350 are spaced from the upper surface 221 of the clamp. Further, in one embodiment each recess 350 is radially aligned with an aperture 228. While recesses 350 are illustrated as extending from the outer circumference 226 toward the inner circumference 224, recesses 350 can also be configured to extend from the inner circumference 224 toward the outer circumference 226 or from the inner circumference 224 to the outer circumference 226 (i.e., entirely through annular body 220). The lower surface 222 of clamp 216 is configured to engage a surface of a disc and provide a downward clamping force.

FIG. 11 illustrates another embodiment of disc clamp 216 comprising force distributing features 240 formed as protrusions 360 on the inner surface 232 of the flange 230. The protrusions 360 are radially positioned between the apertures 228 to increase structural strength in these areas. As with the force distributing features described above, protrusions 360 can be of any suitable shape and size. As illustrated in FIG. 11, one embodiment of protrusions 360 includes protrusions that extend from the inner surface 232 of flange 230 and the lower surface 222 of the annular body 220.

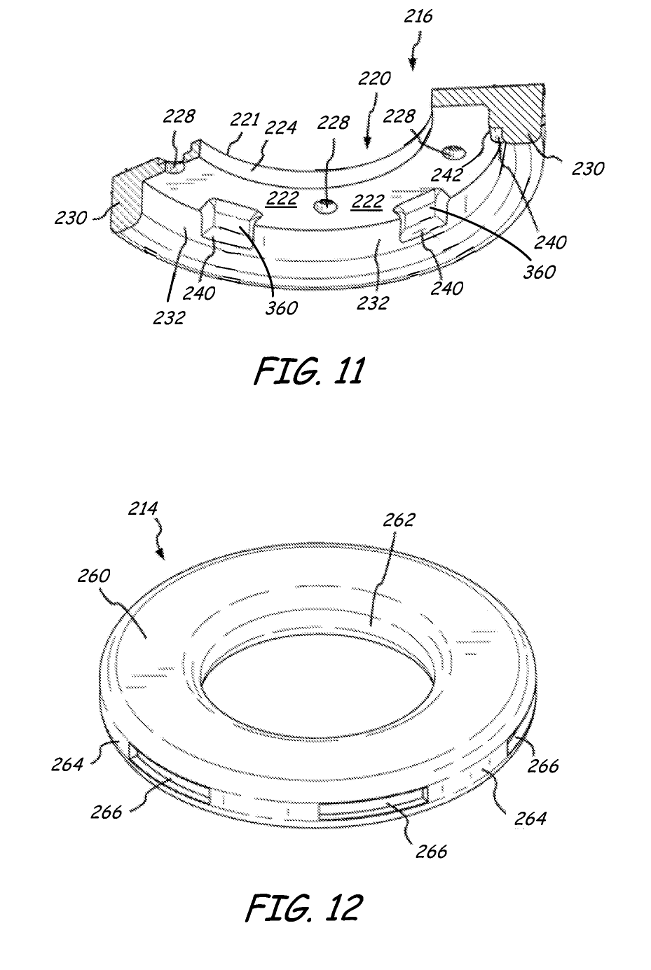

FIG. 12 illustrates one embodiment of the spacer 214 illustrated in FIG. 2 incorporating force distributing features 266. The spacer 214 comprises an annular body 260 having an inner circumference 262 adapted to receive a hub of a disc drive (e.g., hubs 112 or 212). Force distributing features 266 are illustratively similar to recesses 350 described with regard to the disc clamp embodiment of FIG. 10. Features 266 extend from an outer circumference 264 of the spacer 214 toward an inner circumference 262. In other embodiments, the features 266 can be configured to extend from the inner circumference 262 toward the outer circumference 226, or from the inner circumference 224 to outer circumference 226 (i.e., entirely through body 260). In some embodiments of spacer 214, force distributing features 266 are configured to be substantially similar to the embodiments of force distributing features 240 described above.

In embodiments where a spacer 214 includes force distributing features 266, the force distributing features 266 of the spacer 214 are preferably spaced and aligned with the radial locations of the fastener receiving apertures 228 of a disc clamp. For instance, in one embodiment the spacer 214 is positioned on a disc hub, such as disc hub 212 illustrated in FIG. 2, to underlie disc clamp 216. The spacer 214 is positioned such that each of the force distributing features 266 of the spacer 214 lie in the same vertical plane as a fastener 218 of the disc clamp 216. In this manner, the force distributing features 266 are positioned directly (or substantially) under the fasteners 218. The force distributing features 266 operate to distribute clamping forces applied by the fasteners 218 through the disc clamp 216.

In the disclosed data storage system, a distribution of forces from the fasteners (i.e., screws) of the disc clamp to underlying discs is desired to reduce distortion or disc coning. In embodiments described herein, force distribution can be achieved by incorporating force distribution features in the disc clamp and/or spacer(s).

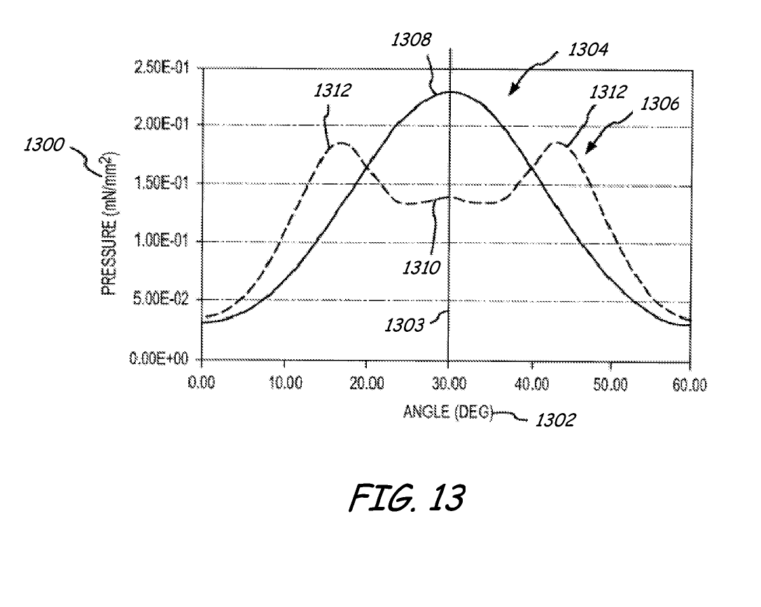

FIG. 13 is a graphical representation illustrating the force distribution characteristics of at least some of the embodiments described herein. The vertical axis 1300 represents the measured pressure or force being exerted on the disk clamp. The horizontal axis 1302 represents the angular location on the clamp corresponding to the measured pressure. The center of a screw hole that receives a securing screw is shown at the vertical line 1303. This position is denoted on the horizontal axis 1302 as being at the 30° angular location. Line 1304 represents the clamping pressure measured for a prior art disk clamp not incorporating the force distributing features described herein. As shown, the pressure or force distribution for the prior art disk clamp provides a parabolic shaped curve wherein the peak 1308 of the curve corresponds with the location of the screw hole. Thus, the maximum pressure is exerted at the screw hole location and the force is very unevenly distributed. Line 1306 represents the clamping pressure measured when the disk clamp incorporates embodiments of the force distributing features described herein. As shown for line 1306, the force is more evenly distributed, noting the lower pressure at point 1310 which corresponds to the location of the screw hole. Two smaller peaks 1312 are shown on both sides of the screw hole. However, these peaks 1312 represent less force than that occurring at peak 1308.

The force distributing features 240 described herein are formed by incorporating weakening or strengthening features in a disc clamp by selectively removing material or thickening material in sections of the disc clamp.

For the incorporation of weakening features, such as openings or recesses, a selected amount of material is removed from areas of the clamp. In one embodiment, the weakening features are radially aligned with the fastener receiving apertures 228 of the clamp 216. In other words, the weakening features are positioned substantially in the same vertical plane as the fasteners (i.e., screws) 218 of the clamp 216. The weakening features operate to cause at least a portion of the clamping forces to be distributed from the weakened areas of the clamp to adjacent areas of the clamp. Thus, the clamping force is more uniformly distributed about the disc clamp.

For the incorporation of strengthening features, such as protrusions, material is added or thickened at selected areas of the clamp. In one embodiment, the strengthening features are radially positioned between the fastener receiving apertures 228 of the clamp 216. In other words, the strengthening features are positioned between, and thus not in the same vertical plane as the fasteners 218 of the clamp 216. The strengthening features operate to cause at least a portion of the clamping forces to be distributed from the weaker areas of the clamp (i.e., the areas proximate the fasteners) to the strengthened areas of the clamp. Thus, the clamping force is more uniformly distributed about the disc clamp.

There are a number of benefits of the disclosed force distribution features. Improved force distribution can be achieved by making relatively simple modifications to a disc clamp, a spacer(s), or both the disc clamp and spacer(s) in a data storage system. In one aspect, conventional fasteners (e.g., screws) can still be used to secure the disc clamp to the hub. In other aspects, the force distributing features can be individually tailored for particular disc pack designs to achieve a desired force distribution, the force distributing features can be arranged in different shapes, sizes, and combinations to provide force distribution adaptable for different disc clamp designs and clamp force distribution is improved, but not at the cost of materially reducing clamp stiffness which otherwise would weaken the overall structural integrity of the clamp.

It is to be understood that even though numerous characteristics and advantages of various embodiments of the disclosure have been set forth in the foregoing description, this disclosure is illustrative only, and changes may be made in detail, especially in matters of structure and arrangement of parts within the principles of the disclosure to the full extent indicated by the broad general meaning of the terms in which the appended claims are expressed. For example, the particular elements can vary depending on the particular application for the consumer electronics while maintaining substantially the same functionality without departing from the scope and spirit of the present invention. In addition, although the preferred embodiment described herein is directed to clamping force distribution in a disc drive, it will be appreciated by those skilled in the art that the teachings of the present invention can be applied to other types of electronics, without departing from the scope and spirit of the present invention.

What is claimed is:

1. A disc clamp comprising:
an annular body having an upper surface, a lower surface, an inner circumference and an outer circumference;
a flange extending from the lower surface of the annular body, the flange having an inner surface oriented towards the inner circumference of the annular body and an outer surface;
a plurality of apertures extending between the upper and lower surfaces of the annular body, the plurality of apertures configured to receive fasteners; and
a plurality of force distributing features formed in the flange between the outer surface of the flange and the inner surface of the flange.

2. The disc clamp of claim 1, wherein the flange is integrally formed with the annular body.

3. The disc clamp of claim 1, wherein the flange is substantially orthogonal to the annular body.

4. The disc clamp of claim 1, wherein the plurality of force distributing features comprise a plurality of openings extending from the inner surface of the flange to the outer surface of the flange.

5. The disc clamp of claim 1, wherein the plurality of force distributing features comprise a plurality of recesses formed in the flange, wherein the recesses extend from the inner surface of the flange toward the outer surface of the flange.

6. The disc clamp of claim 1, wherein the plurality of force distributing features comprise a plurality of recesses formed in the flange, wherein the recesses extend from the outer surface of the flange toward the inner surface of the flange.

7. The disc clamp of claim 1, wherein each of the plurality of force distributing features is radially aligned with one of the plurality of apertures formed in the annular body.

8. The disc clamp of claim 1, wherein the plurality of force distributing features are spaced from the lower surface of the annular body.

9. The disc clamp of claim 1, wherein the plurality of force distributing features have a shape selected from the group consisting of rectangular, elliptical, triangular, and circular.

10. The disc clamp of claim 1, wherein the inner circumference of the annular body is adapted to receive a hub of a disc drive, and wherein the apertures formed between the upper and lower surfaces of the annular body are adapted to receive screws for securing the disc clamp to the hub.

11. A disc pack comprising:
a hub adapted to receive at least one disc;
a disc clamp adapted to engage the hub and secure one or more discs to the hub, the disc clamp comprising:
an annular body having an upper surface, a lower surface, an outer circumference defining a peripheral edge of the clamp, and an inner circumference adapted to receive the hub;
a plurality of apertures extending between the upper and lower surfaces of the annular body, the apertures configured to receive fasteners for securing the disc clamp to the hub; and
a plurality of force distributing features formed between the peripheral edge and the inner circumference of the annular body.

12. The disc pack of claim 11, wherein the plurality of force distributing features comprise a plurality of recesses formed in the annular body, wherein the recesses extend from the peripheral edge toward the inner circumference of the annular body.

13. The disc pack of claim 11, wherein each of the plurality of force distributing features is radially aligned with one of the plurality of apertures formed between the upper and lower surfaces.

14. The disc pack of claim 11, wherein the plurality of force distributing features have a shape selected from the group consisting of rectangular, elliptical, triangular, and circular.

15. The disc pack of claim 11, and further comprising:
a flange extending from the lower surface of the annular body, the flange having an outer surface, an inner surface facing the inner circumference of the annular body, and a lower surface, wherein the force distributing features are formed of material in the flange between the outer surface and the inner surface, and wherein the lower surface of the flange forms the bottom surface of the clamp.

16. The disc pack of claim 11, and further comprising:
a spacer having an annular body and a plurality of force distributing features formed in the annular body, wherein the annular body has an inner circumference adapted to receive the hub and an outer circumference, and wherein the plurality of force distributing features are radially spaced about the annular body of the spacer and formed between the outer circumference and the inner circumference.

17. A disc clamp comprising:
an annular body having an upper surface, a lower surface, an outer circumference, and an inner circumference;
a plurality of apertures extending between the upper and lower surfaces of the annular body and adapted to receive fasteners; and
means for distributing force that is spaced about the disc clamp between the inner circumference and the outer circumference.

18. The disc clamp of claim 17, and further comprising:
a flange extending from the lower surface of the annular body and orthogonal to the lower surface of the annular body, the flange having an outer surface, an inner surface oriented towards the inner circumference of the annular body, and a lower surface forming at least a portion of the bottom surface of the clamp.

19. The disc clamp of claim 18, wherein the means for distributing force is formed in the flange between the outer surface and the inner surface, and wherein the means includes one of openings that extend from the inner surface to the outer surface, recesses that extend from the inner surface toward the outer surface, and recesses that extend from the outer surface toward the inner surface.

20. The disc clamp of claim 18, wherein the means for distributing force comprises protrusions formed on the inner surface of the flange and on the lower surface of the annular body.
